(19) United States
(12) Patent Application Publication
(10) Pub. No.: US 2014/0107933 A1
(43) Pub. Date: Apr. 17, 2014

(54) GENE EXPRESSION BARCODE FOR NORMAL AND DISEASED TISSUE CLASSIFICATION

(71) Applicant: The Johns Hopkins University, (US)

(72) Inventors: Rafael A. Irizarry, Baltimore, MD (US); Michael J. Zillio, Atlanta, GA (US)

(73) Assignee: The Johns Hopkins University, Baltimore, MD (US)

(21) Appl. No.: 13/859,222

(22) Filed: Apr. 9, 2013

Related U.S. Application Data
(63) Continuation of application No. 12/312,922, filed on Dec. 23, 2009, now abandoned.
(60) Provisional application No. 60/861,817, filed on Nov. 30, 2006.

(51) Int. Cl. G06F 19/20

(52) U.S. Cl. CPC G06F 19/20
USPC 702/19

(57) ABSTRACT

A computer-based method of creating a gene expression barcode includes the steps of determining an intensity of expression for each gene in a set of genes in a plurality of samples for at least one type; selecting genes in the set of genes that have at least two expression modes, based on the intensity; and creating a gene expression reference barcode, wherein each barcode bar corresponds to a selected gene and wherein the bar value is coded according to whether an intensity value for a selected gene is below or above a threshold value.

The gene expression reference barcodes may then be compared with a similarly created barcode for a sample, for the purposes of identifying the sample, diagnosing a disease, and/or predicting a prognosis of a disease.

### GOVERNMENT AGENCY

The invention disclosed herein was developed in part under grant no. AI 23047 from the National Institutes of Health. The U.S. Government has certain rights in the invention.

### BACKGROUND OF THE INVENTION

1. Field of the Invention

The present invention relates generally to automated techniques for classifying samples of sources for RNA, and detecting disease, and more particularly to a technique for creating a gene expression barcode for use in classification, diagnosis, prognostication, and detection.

2. Background Information

The ability to measure genome-wide gene expression holds great promise for characterizing cells and distinguishing diseased from normal tissues. Thus far, microarray technology has only been useful for measuring relative expression between two or more samples, which has handicapped the ability of microarrays to classify tissue types.

The high throughput analysis of cells and tissues is revolutionizing biological research. The ability of microarrays to measure thousands of RNA transcripts at one time allows for the characterization of cells and tissues in greater depth than was previously possible, but has not yet led to big advances in diagnosis or treatment. Progress has been slowed by questions regarding reproducibility, with early studies reporting poor correlation between platforms [references 1-3]. Subsequent research has demonstrated that platform specific feature effects are the major cause of the observed disagreement [4].

Feature characteristics, such as probe sequence, feature size and quality, and label/transcript interactions can cloud the relationship between observed intensity and actual expression. Affymetrix probes may be designed to measure the same transcript would commonly result in intensities differing by fold-changes of ten or more [5]. Although this probe effect is large it is also very consistent across different hybridizations, which implies that relative measures of expression are substantially more useful than absolute ones. To understand this, consider that when comparing intensities from different hybridizations for the same gene, the probe effect is very similar and cancels out. On the other hand, when comparing intensities for two genes from the same hybridization, the different probe effects can alter the observed differences. For this reason the overwhelming majority of results based on microarray data rely on measures of relative expression. Genes are reported to be differentially expressed rather than expressed or unexpressed. Recent platform comparisons find much better concordance when considering relative expression measures [4, 6-11]. These reproducibility issues have caused many authors to urge caution towards the use of microarrays, especially for clinical diagnostics [12,13]. However, recent evidence suggests that the problems associated with microarray experiments are being controlled. Studies with rigorous experimental designs have found cross-platform correlations to be quite high [4,6-11]. The weight of the evidence now suggests microarrays can provide highly specific, reproducible results when properly used.

However, comparing results across studies remains a difficult task. Lab and batch effects can have a large impact on results. The methods used to process raw data into gene level measurements also contribute to variability, with the background correction procedure having the largest effect on performance [10, 14]. These are likely culprits for some of the reproducibility issues seen in downstream applications such as the use of gene expression data to classify cells or tissues. A number of recent studies have demonstrated that the correlation between predictive gene lists is quite low. For example, Ein-Dor et al. found, upon reanalysis of published data, that many predictive gene lists were possible, depending on the subset of patient samples used in the training set [16].

### SUMMARY OF THE INVENTION

In an exemplary embodiment of the present invention a system, method and computer program product for a gene expression barcode for classification of normal and diseased tissue is disclosed.

Exemplary embodiments of the present invention provide a technique that may successfully classify an unknown sample by comparing the unknown sample to a set of known samples using an exemplary gene expression barcode. Embodiments may be used, for example, to predict tissue type based on data from a single microarray hybridization. The technique may include a statistical procedure that is able to accurately demarcate expressed from unexpressed genes and define a unique gene expression barcode for each tissue type. The gene expression barcodes may be used by a barcode-based classification technique that may have better predictive power than the conventional techniques.

In an exemplary embodiment, hundreds of publicly available human and mouse arrays were used to define and assess the performance of the barcode. With clinical data, a near perfect predictability of normal from diseased tissue for three cancer studies and one Alzheimer's disease study was found. The barcode method may also discover new tumor subsets in previously published breast cancer studies that can be used for the prognosis of tumor recurrence and survival time.

In an exemplary embodiment, the present invention may be a computer-based method of creating a gene expression barcode, comprising: determining an intensity of expression for each gene in a set of genes in a plurality of samples for at least one tissue type; selecting genes in the set of genes that have at least two expression modes, based on the intensity; and creating a gene expression reference barcode, wherein each barcode bar corresponds to a selected gene and wherein the bar value is coded according to whether an intensity value for a selected gene is below or above a threshold value.

In another exemplary embodiment, the present invention may be a computer-readable medium comprising instructions, which when executed by a computer system causes the computer system to perform operations for creating a gene expression barcode, the operations comprising: determining an intensity of expression for each gene in a set of genes in a plurality of samples for at least one tissue type; selecting genes in the set of genes that have at least two expression modes, based on the intensity; and creating a gene expression reference barcode, wherein each barcode bar corresponds to a selected gene and wherein the bar value is coded according to whether an intensity value for a selected gene is below or above a threshold value.

In another exemplary embodiment, the present invention may be a computer-based method for classification of a biological sample, comprising: generating a gene expression barcode for a sample; comparing the gene expression barcode to at least one reference gene expression barcode; and identifying a tissue type of the sample based on a closest distance to one reference gene expression barcode.

In another exemplary embodiment, the present invention may be a computer-based system for using a gene expression barcode comprising: a database containing at least one gene expression reference barcode for at least one tissue type; a barcode generator for generating a gene expression barcode for a sample; a classification and diagnostic tool for identifying a tissue type of the sample by comparing the gene expression barcode of to the at least one gene expression reference barcode; and means for outputting a result of the comparing.

The present application claims priority to U.S. Patent Application No. 60/861,817, Confirmation No. 8622, filed Nov. 30, 2006 entitled “Gene Expression Barcode for Normal and Diseased Tissue Classification,” to Irizarry et al., of common assignee to the present invention, the contents of which are incorporated herein by reference in their entirety. The references disclosed herein are incorporated by reference.

Further features and advantages of the invention, as well as the structure and operation of various embodiments of the invention, are described in detail below with reference to the accompanying drawings.

### DEFINITIONS

The following definitions are applicable throughout this disclosure, including in the above.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and an apparatus that may accept data, may process data in accordance with one or more stored software programs, may generate results, and typically may include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet. Exemplary networks may operate with any of a number of protocols, such as Internet protocol (IP), asynchronous transfer mode (ATM), and/or synchronous optical network (SONET), user datagram protocol (UDP), IEEE 702.x, etc.

The terms “gene,” “gene barcode,” “gene expression barcode,” and the like, are used throughout. The compositions and methods are intended to also include barcodes that are determined, for example, at the probe and exon level. For certain Affymetrix chips there are 11 probes per gene. After a sample is run on a chip, the probe intensity values are summarized to get one value for the entire gene. This may be part of preprocessing. The “gene” expression barcode is calculated on this data level. However, it is also possible to compute the expression barcode on the probe or exon level, which may increase accuracy or resolution. For example, Affymetrix probes may fall into different exons of a gene and it may be useful to determine the barcode on this level. Furthermore, exon arrays have recently become available, and are expected to be particularly useful in some applications.

### BRIEF DESCRIPTION OF THE DRAWINGS

The foregoing and other features and advantages of the invention will be apparent from the following, more particular description of exemplary embodiments of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 depicts an overview of an exemplary system of the present invention;

FIG. 2 depicts an exemplary embodiment of tissue types according to the present invention;

FIG. 3 depicts a flowchart of an exemplary technique for creating a reference gene expression barcode according to the present invention;

FIG. 4 depicts a flowchart of an exemplary technique for classifying a tissue and/or diagnosing a disease and predicting a disease prognosis according to the present invention;

FIGS. 5A-B depict an exemplary estimate of expression distribution for two human genes, according to the present invention;

FIGS. 6A-B depict exemplary boxplots for the same respective genes as in 5A and 5B, where the calls are stratified by tissue;

FIGS. 7A-B depict two new tissue types that were identified based on barcode comparison with breast cancer tumors;

FIG. 8 depicts a dendrogram obtained by using hierarchical clustering on barcodes for human tissues;

FIG. 9 an exemplary architecture for implementing a computer, according to embodiments of the present invention; and

FIG. 10 depicts a computer system for use with embodiments of the present invention.

### DETAILED DESCRIPTION OF EMBODIMENTS OF THE PRESENT INVENTION

An exemplary embodiment of the invention is discussed in detail below. While specific exemplary embodiments are discussed, it should be understood that this is done for illustration purposes only. A person skilled in the relevant art will recognize that other components and configurations can be used without parting from the spirit and scope of the invention.

Exemplary embodiments of the present invention may be embodied as software, hardware, or combinations of software and hardware

References herein to a “sample,” a “tissue,” a “cell,” or the like may include any biological substance from which RNA can be extracted, including cultured cell lines and purified cells from living things, i.e. humans, mice, horses, plants, bacteria, yeast, etc.

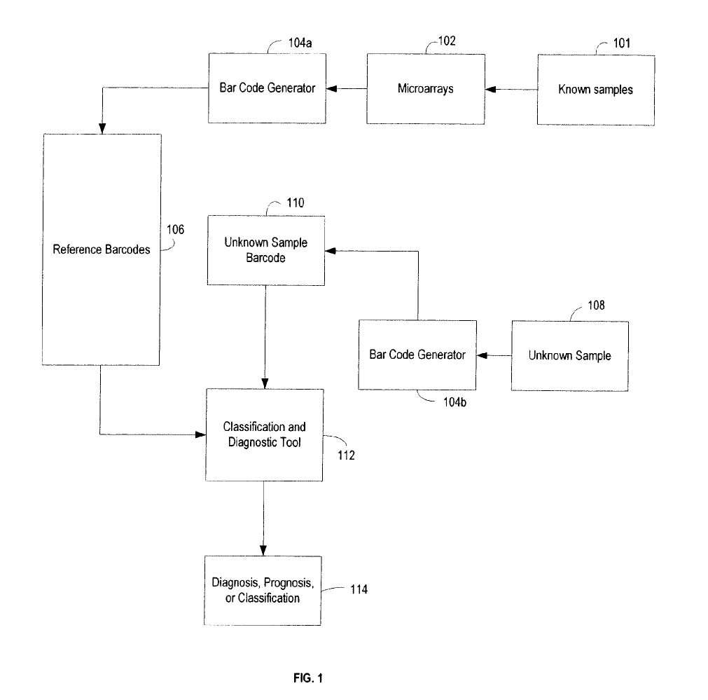

FIG. 1 illustrates an overview of an exemplary system of the present invention. Samples 101 of known origin are processed to create microarrays 102, which may be, for example, gene microarrays or exon microarrays, or other sources of gene expression data. Microarrays 102 are received in the barcode generator 104a. The barcode generator 104a may use the intensity of gene expression over one or more samples to determine whether a gene is expressed, and generates one or more gene barcodes 106, which may be used as reference barcodes. The term “gene barcode” used herein is not limited only to barcodes created from genes on a microarray. Barcodes may also be created, for example, for sets of individual gene probes, or individual exons.

An unknown sample 108 may be input into a barcode generator 104b, which may be the same instantiation of barcode generator 104a, or may be a different instantiation or may be differently implemented than 104a. Barcode generator 104b may produce a barcode 110 for unknown sample 108 that is in a format such that barcode 110 may be compared with reference barcodes 106.

A classification and diagnostic tool 112 may compare the barcode 110 to the reference barcodes 106 and produce a diagnosis or prognosis 114 of a disease condition in the unknown sample 108 and/or a classification of unknown sample 108.

The barcode generator may generate a separate barcode for each tissue type. A tissue type may be any characteristic of a biological substance capable of being uniquely represented by the expression of genes in the substance. The term “tissue type” is not limited to tissues, and may also apply to types of any biological substance from which RNA can be extracted. Further, while mammalian features are generally described herein, the techniques and classifications of the exemplary embodiments may apply as well to other species, including, but not limited to, plants, fungi and bacteria.

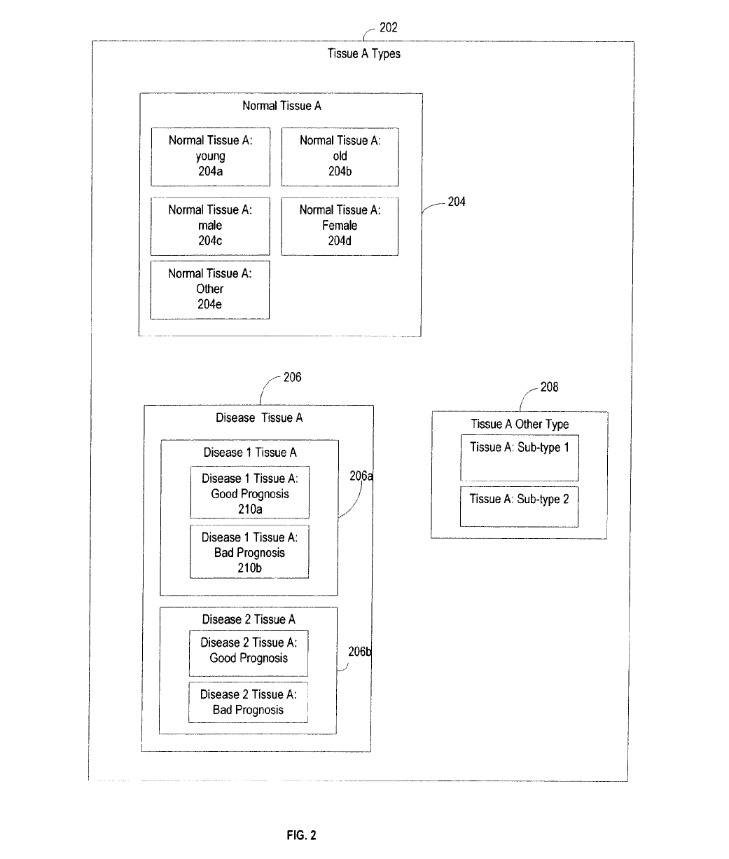

FIG. 2 illustrates some examples of tissue types. Tissue “A” 202 may generally come from one specific organ, for example, skin, lungs, liver, ovary, heart, brain, etc. Tissue A may have sub-types of: normal 204, diseased 206, and/or other 208. Normal tissue 204 may have further sub-types, e.g. old 204a, young 204b, male 204c, female 204d, other 204e, etc. Each sub-type may have additional sub-types, for example, one tissue type could be “normal, young, male”. Other types 208 may include, for example, species, drug treatment, time, pathogen exposure, gene knock-out, etc. Any experimental sample may be considered a type or sub-type.

Diseased tissue 206 may have sub-types 206a, 206b according to specific diseases, e.g. cancer, diabetes, Alzheimer's disease. Each specific disease sub-type may have sub-types according to known or statistical prognosis, e.g. good prognosis 210a and bad prognosis 210b.

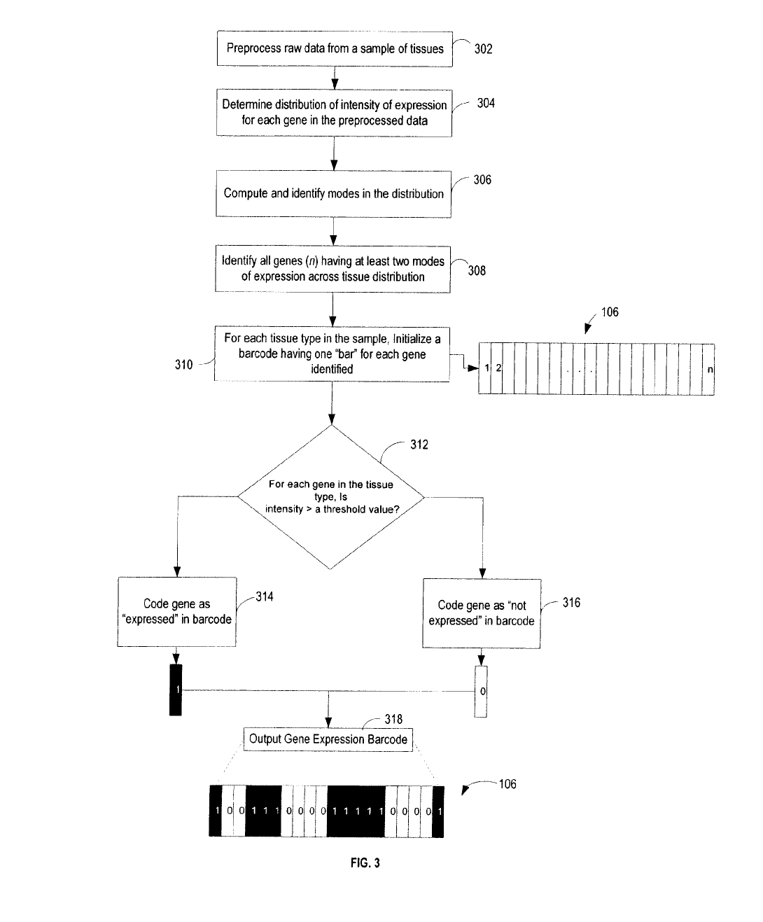

FIG. 3 depicts a flowchart for a technique that may be performed by barcode generator 104a for selecting genes that may form the basis for one or more reference gene expression barcodes 106. In block 302, the raw data from samples of tissue types may be pre-processed using, for example, robust multi-array analysis (RMA). Other methods of preprocessing, for example, dChip, gcRMA, MAS 5.0, and others may also be used. The raw data may be from, for example, microarrays obtained by means familiar to those in the art (e.g. GeneChip® Arrays (Affymetrix), Agilent, Clontech, ABI, GE Healthcare, etc., or from private or public repositories of gene expression data. In block 304, for each gene in the preprocessed data, the intensity of expression of that gene may be determined across the entire distribution of tissues in the sample. In an exemplary embodiment, determining the intensity distribution may be done by computing the median log₂( ) expression estimate for each gene, and estimating the expression distribution of that gene across tissues with an empirical density smoother. In one embodiment, relative intensities from raw data, which may be in the form of pixels, are then converted into binary data, either “expressed” or “unexpressed”, as described herein below.

In block 306, the local modes of the gene intensity distribution may be computed and the mode with the smallest location may be considered the expected intensity of an unexpressed gene. Expression estimates having intensity values smaller than the “smallest location mode” may then be used to estimate the standard deviation of unexpressed genes. In some embodiments, a constant K may be defined such that genes where the log expression estimates were K standard deviations larger than the unexpressed mean are considered to be expressed. In an exemplary embodiment, K=6.

In block 308, genes having at least two modes of expression intensities are selected for creation of the gene expression barcode, which may help avoid repetitive information. Genes showing only one mode are likely to be considered either expressed in all tissues or unexpressed in all tissues. These genes do not provide information for classification purposes, as described herein.

In block 310, for each tissue type, a barcode 106 may be created and initialized, where each “bar” in the barcode corresponds to one gene (or probe or exon) selected in 308. The tissue type barcode values may be set by determining, in block 312, whether a gene intensity is greater than a threshold value. The threshold value may be related to the unexpressed mean, for example, constant K times the unexpressed mean. For genes having a higher intensity than the threshold, the gene is considered expressed, and the corresponding bar in the barcode may be set to one binary value 314, for example, one, or “black”. For genes not having an intensity higher than the threshold, the gene is considered not expressed, and the corresponding bar may be set to a second binary value 316, for example, zero, or “white”.

In an exemplary embodiment, the barcode may be a data structure, such as, but not limited to, a vector, an array, a linked list, a database table etc. having one element corresponding to one selected gene. A data structure element may be single valued, for example, storing only the value of the bar. Alternatively, the data structure element may be multi-valued, holding, for example, the value of the bar, the intensity of the gene, the standard deviation associated with not being expressed for the gene, or other data associated with the gene. In an exemplary embodiment, the barcode for each tissue may be defined by averaging the zeros and ones. The tissue barcode may contain any value between 0 and 1. However, for most genes exemplified herein, these proportions were close to 0 or 1, with about 50% of them exactly 0 or 1.

The mean log intensity and standard deviation associated with not being expressed may also be saved for each gene, either in the barcode, or separately. In an exemplary embodiment, once the barcode is generated, it may be output, in block 318, for example, to a display, to a file and/or database stored on a computer-readable medium, to a printer, or over a network to another computer or output means.

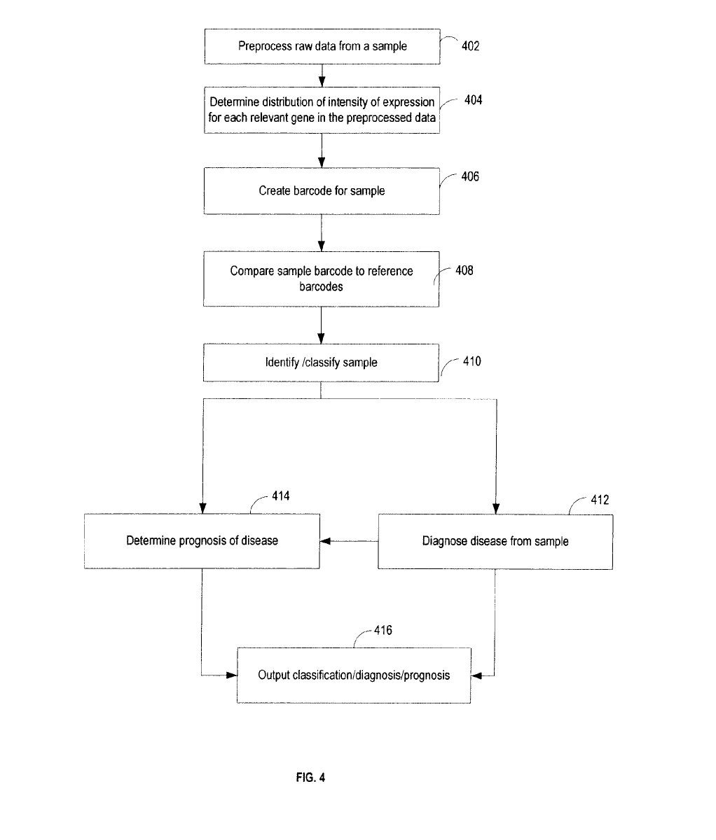

FIG. 4 shows a flowchart for classifying a new tissue or cell sample, or diagnosing a disease. The technique may be performed, at least in part, by classification and diagnostic tool 112. To classify a new sample, data from the sample may be preprocessed in 402, as in 302. Then the intensity of expression of the relevant genes in the sample may be determined in 404, as in 304. The barcode for the sample may then be created in 406, as in 310-316. The sample barcode may then be compared with the gene reference barcodes 106 in 408. Comparing the barcodes may include computing a distance from the sample to each gene reference barcode. The gene reference barcode that is closest in distance to the sample barcode may then serve to identify the sample tissue. The distance between barcodes may be determined, for example, by calculating a Euclidean distance, which may be defined as the number of genes that are expressed in one sample and not expressed in the other.

Identifying or classifying the tissue or cell sample may further include diagnosing a disease in 412, and/or determining a prognosis of a disease in 414. If a gene reference barcode exists for a disease tissue type, that disease tissue type barcode may be closest to the tissue sample barcode. Similarly, if a gene reference barcode exists for a disease prognosis, that disease prognosis type barcode may be closest to the tissue sample barcode. Identifying and classifying a sample may also include determining a tissue of origin for a metastatic cancer.

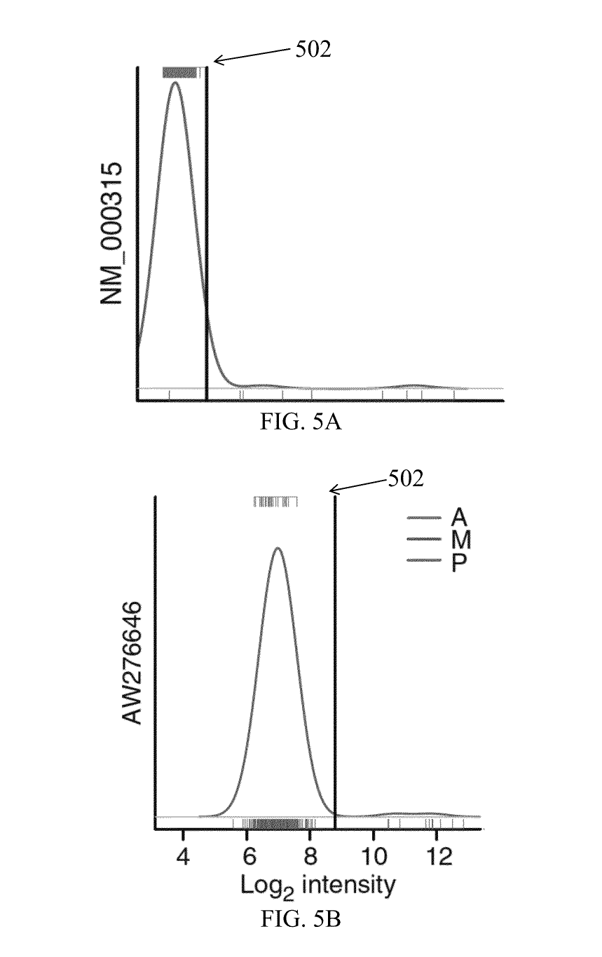

FIGS. 5A and 5B show the estimate of expression distribution for two human genes. The vertical line 502 may be automatically drawn by the barcode method and distinguishes the intensity range associated with expressed and unexpressed genes.

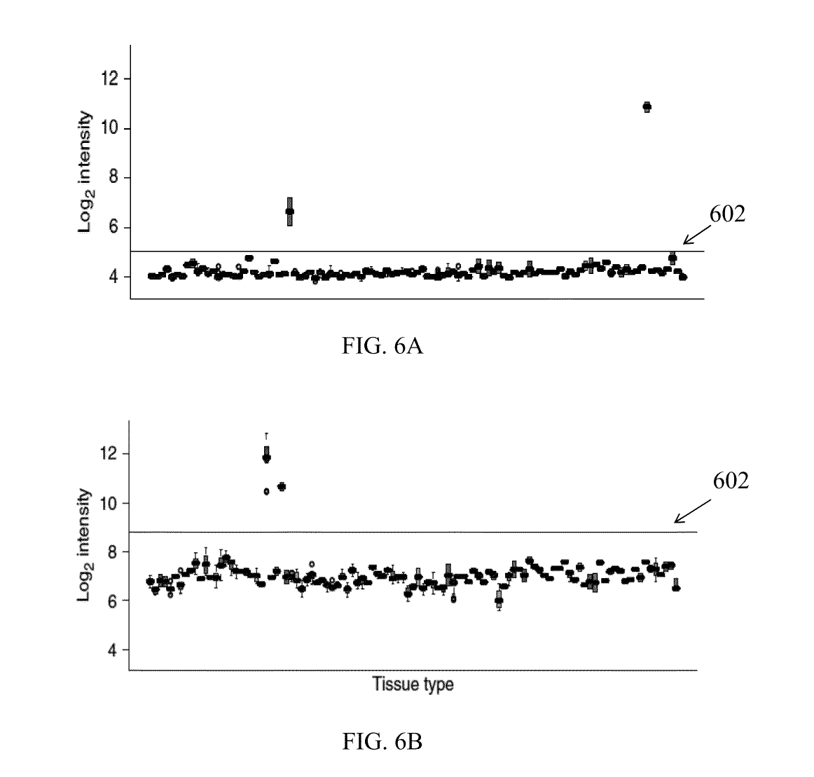

FIGS. 6A and 6B show boxplots for the same respective genes as in 5A and 5B, where the calls are stratified by tissue. The horizontal line 602 denotes the expressed/unexpressed boundary. Notice that all samples of the same tissue are consistently present or consistently absent.

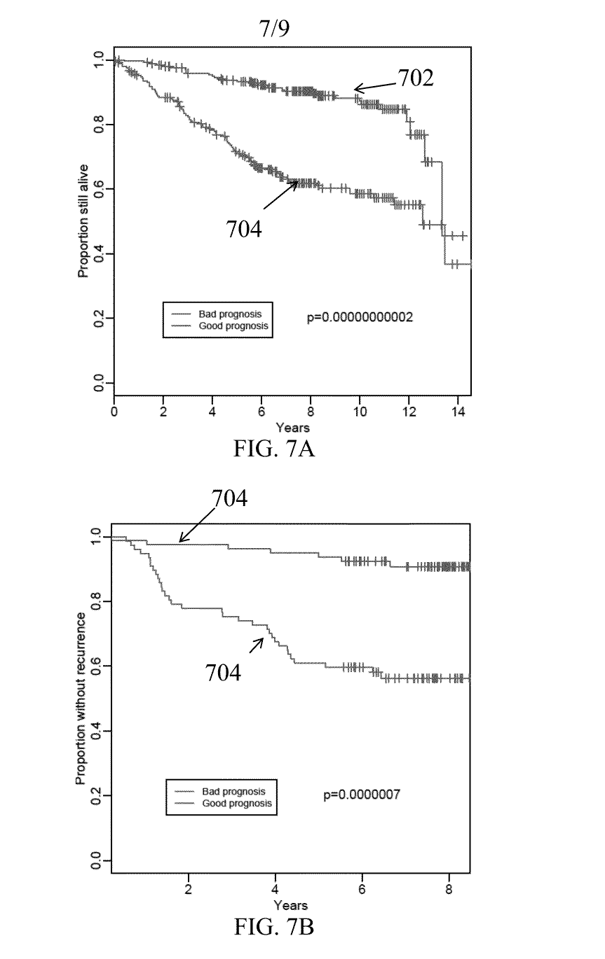

FIGS. 7A-B illustrate two new tissue types that were identified based on the breast cancer tumors having barcodes that were more similar to normal and cancer tissue barcodes, respectively. The two new tissue types were denoted the good prognosis and bad prognosis tissue types. Each of the breast tumor samples were classified into either good or bad prognosis using the minimum distance to reference samples as described above. Survival data was not used to define the barcodes nor to classify the samples. FIG. 7A shows survival curves for good prognosis 702 and bad prognosis 704 groups for the data used in the survival studies described by: Miller et al. and Pawitan et al. FIG. 7B shows survival curves for good prognosis 702 and bad prognosis 704 groups for the data for relapse-free survival time data described by Sotiriou et al.

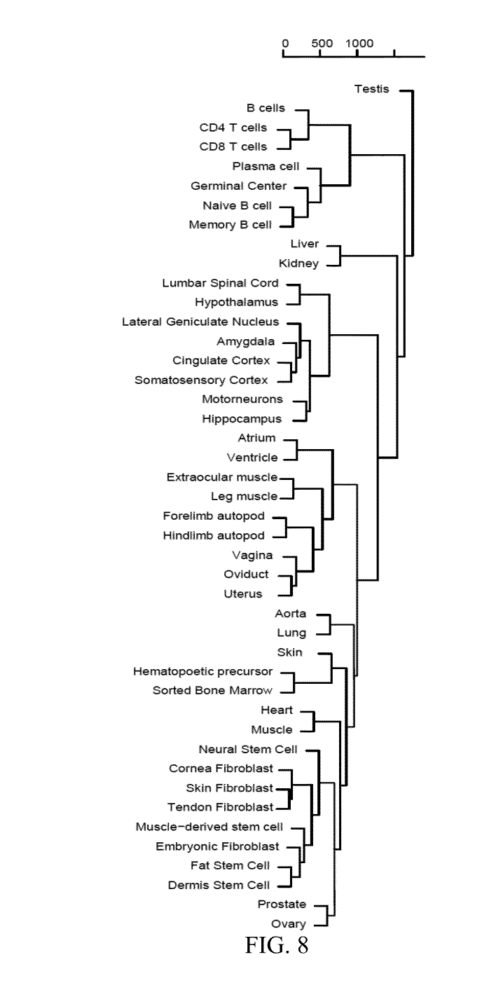

FIG. 8 illustrates a dendrogram obtained by using hierarchical clustering on barcodes for human tissues. Tissues closest together on the dendogram are the tissues having barcodes closest in distance.

### EXEMPLARY EMBODIMENT

For any given gene, it is desirable to know what intensity of expression relates to no expression. Hypothetically, one way to determine this intensity would be to hybridize tissues for which the gene is known not to be expressed and to look at the distribution of the observed intensities. If a new sample were then provided, to determine if a gene is expressed one could compare the observed intensity to the previously formed distribution. We could then report, for example, an empirical p-value. However, for a single lab, creating this training dataset is logistically impossible for two reasons: 1) it is not known what genes are expressed in which tissues, and 2) it would require various hybridizations for each gene.

Fortunately, a preliminary version of such a dataset already exists for some platforms/organisms. Samples were obtained for more than a hundred tissue-types from the public repositories Gene Expression Omnibus (GEO) and ArrayExpress [22, 23] (more details are given below). Following the exemplary embodiments described above, for each gene, the intensity distribution was determined. Because it is expected that any given gene will only be expressed in some tissues, multiple modes should be observed. It is assumed that the lowest intensity mode is due to lack of expression, as seen in FIGS. 5 and 6. Using this approach, genes that are expected to be expressed are coded with ones and the unexpressed genes are coded with zeros. This information is referred to as the gene expression barcode.

Publicly available mouse and human data were used to demonstrate the usefulness of this procedure. The Affymetrix HGU133A, MOE430A and MOE430 2.0 chips were chosen. To have a wide representation of tissues, control samples were obtained for which the raw data (CEL files) were available. To demonstrate the potential of the barcode method in a clinical setting, data were also obtained from seven studies: 1) Landfield et al. examined different severities of Alzheimer's disease[24]. 2) Kimchi et al. compared normal squamous epithelium to adenocarcinoma and its precursor [25], while 3) Dyrskjot et al. compared different grades of bladder cancer [26]. 4) Lenburg et al. studied renal cell carcinomas [27] and 5) Miller et al. [28], 6) Pawitan et al. [29] and 7) Sotiriou et al. [30] examined breast tumors. The data quality for each study was verified by visual inspection and by using the affyPLM package [31]. Author-assigned tissue types were used for each sample. This resulted in a database of 1092 human samples representing 118 different tissues obtained from 40 different studies. Of these, 498 were normal tissues, 500 were breast tumors, and 94 were other diseases. The mouse data were formed from 236 normal samples from different strains representing 44 different tissues obtained from 24 different studies.

The raw data for each platform were preprocessed using Robust Multi-array Analysis (RMA) [32]. Then for each gene the median log (base 2) expression estimate was computed and an empirical density smoother was used to estimate the expression distribution of that gene across tissues. The modes of this distribution were then computed and the mode with the smallest location was considered the expected intensity of an unexpressed gene. Expression estimates to the left of this mode were then used to estimate the standard deviation of unexpressed genes. A constant K was selected. Expressed genes were defined as the genes expressed in tissues where the log expression estimates were K standard deviations larger than the unexpressed mean. Cross-validation assessments found K=6 to be an optimal choice in this instance.

FIGS. 5 and 6 also demonstrate how the barcode approach deals with the probe effect: the unexpressed mean for the two genes differs by more than four fold. Without the aid of hundreds of samples, this difference would not be evident, and it would be impossible to relate observed expression to presence or absence of the transcript.

To avoid repetitive information, only genes showing two or more modes in their across tissue distribution were included. Genes showing only one mode are likely to be considered either expressed in all tissues or unexpressed in all tissues. These genes do not provide information for classification purposes. There were 2519 human genes and 5031 mouse genes that survived this filter. Approximately 75% of the barcode genes encode membrane or extracellular proteins, while approximately 15% encode nuclear proteins (data not shown). This procedure converts the vector of expression estimates into a vector of zeros and ones providing a barcode for each sample. The barcode for each tissue was defined by averaging the zeros and ones. Notice that the tissue barcode can contain any value between 0 and 1. However, for most genes these proportions were close to 0 or 1, with about 50% of them exactly 0 or 1.

The mean log intensity and standard deviation associated with not being expressed were then saved for each gene. To classify a new sample, the sample's barcode may be obtained and the distance from each tissue barcode is computed by calculating the Euclidean distance. The predicted tissue type is the barcode that minimizes this distance.

A gene expression barcode was created for over 100 human tissues and compared to the present/absent/marginal calls from the Affymetrix Microarray Suite 5.0 (MAS 5.0). With MAS 5.0, only 10% of the 22215 genes represented in the human array achieve the same call in all samples within the same tissue. This number increases to 48% using the barcode approach. Similar results were obtained with the mouse data: 12% and 49% of the 22626 genes achieve the same call in all samples within the same tissue for MAS 5.0 and the barcode respectively. To assess sensitivity we used results from a extensive study that reported proteins present in various mouse tissues [33]. We mapped the proteins to genes represented in the Affymetrix arrays and found that the barcode was more sensitive at declaring genes, approximated by proteins found in the tissues, present.

Because studies usually target a particular tissue, or similar tissues, a primary concern when classifying tissues is that a strong lab effect will confound the ability to classify tissues from the ability to classify labs [4]. In such a case, correlations between samples from a study may be high despite originating from a wide variety of tissues. The barcode approach can remove many of these effects because subtle changes in intensity values are not strong enough to make an absent gene appear present, or vice-versa. Use of the barcode may removes most of the erroneous correlations without removing the correlation between actually similar tissues.

Various sample classification algorithms have been proposed for microarray data [34-36]. A number of these algorithms were compared on the original expression estimates, with Predictive Analysis of Microarrays (PAM) producing the best results (data not shown) [35]. We compared the ability to predict among normal tissues and clinical samples. The barcode outperformed PAM in all comparisons except two, where it performed as well as PAM.

The breast cancer studies cited above did not include normal breast tissue samples, but the studies did include patient survival data [28-30]. The survival data allowed testing of the barcode technique's ability to find undiscovered tissue subsets. Since normal tissue was not available, the Euclidean distance to all tissue barcodes was obtained. If we included the breast tumor barcode, 499 of the 500 samples were classified as breast tumor (1 as bladder cancer). When we took out the breast tumor barcode, then a first set of samples was close to a variety of normal tissues and the other set of samples was close to a variety of cancer tissues. We then formed good and bad prognosis barcodes using these first and second sets of samples, respectively. This new barcode was then used to re-classify the 500 samples. We iterated this procedure until the good and bad prognosis groups did not change. The final barcodes resulted in a powerful prognosis tool as demonstrated by the survival curves seen in FIGS. 7A and 7B. FIG. 7A combines survival data from all three studies. FIG. 7B shows the results for the Pawitan et al. study, which was the only study to report relapse-free survival time. The survival curves for the good and bad prognosis groups are significantly different for both survival (p<10-10) and relapse-free survival (p<10-6) times.

For survival information, the barcode approach may provide better separation than all the approaches compared by Miller et al. We examined the effect on survival of various variables, as done in Table 3 of Sotiriou et al. The barcode variable had a larger effect than the gene expression grade variable presented by Sotiriou et al. An analysis similar to the one presented by van de Vijver et al. demonstrated that the barcode performs similarly to the approach described by van de Vijver et al at predicting disease free survival past 5 years [37].

Finally, we fitted a multivariate Cox proportional hazards model including relative distance to the good prognosis barcode as a continuous variable instead of the dichotomous good/bad prognosis variable. Relative distance was defined as the percentage closer to the good prognosis barcode compared to the bad prognosis barcode. This analysis suggested that for every percentage increase the risk of not surviving increased 9%.

The exemplary embodiments of the barcode technique described herein provide one estimate of expression for each gene and each sample. For Affymetrix data, various algorithms exist and the resulting gene-level estimates can vary widely, making the data from different laboratories difficult to compare. Furthermore, normalization works best when performed at the raw data level [38]. Therefore, all samples included in this study were normalized together at the raw data level and summarized with RMA.

Only 2619 human genes and 5031 mouse genes are included in the barcode, because at least two clear modes must be observed in the across sample expression estimate distribution for a gene to pass the filter. There are a number of possible reasons most genes were excluded. Some genes are not expressed in any of the studied tissues, so with increased data coverage more genes will be included. It is possible some genes are expressed in all the tissues and would not be useful in the barcode algorithm. Due to biological (i.e. alternative splicing) or technical factors (i.e. cross-hybridization), results in gene expression estimates can have a wide range of values. For example, Zhang et al. found that 20% of probes were nonspecific and could cross-hybridize or were mistargeted on both the Affymetrix U95A and U133A chips [39]. Unannotated splice variants may also be a major contributing factor to these disparate results. When these problematic probes are accounted for, studies find much better concordance [6-8]. As more genes, or exons, are included in the barcode, and as probe selection improves, classification results for our barcode procedure should improve dramatically. It is unclear why more genes passed filtering from the mouse data, but it may be due to the number and variety of tissues included in the analysis.

The normalization procedure used by RMA, quantile normalization, forces feature intensities for all samples to be the same [38]. Thus, it was surprising that the lab effect somehow persisted. We find that feature/sample interactions result in small yet consistent artifacts that are not removed even with the strongest normalization procedures. Because this bias affects various genes, the aggregate effect can alter results obtained with expression data. However, the effects are not large enough to change the expressed/unexpressed calls that form the barcode, making this new procedure robust to the lab, batch and lot effects. An illustrative example was seen when analyzing the bladder cancer data from Dyrskjot et al. This publication reports almost perfect clustering between carcinoma in situ+(CIS+) and CIS− tumors. The barcode was not able to detect this difference. However, upon close inspection we noticed that, with the exception of three samples, the 12 CIS+ and 16 CIS− were hybridized nine months apart. Furthermore, we found that the normal tissues clustered perfectly by time of hybridization. It is likely that many of the genes that differentiate the CIS+ and CIS− samples are actually distinguishing the two hybridization times. The barcode approach is protected from these batch effects. A gene may show highly significant differences (p=0.000013) between normal samples hybridized at different times. However, all the samples are called unexpressed by the barcode. The batch effect is not strong enough to change the expessed/unexpressed call. Similarly, the difference between CIS+ and CIS− is highly significant (p=0.0000073), yet the samples are all called unexpressed. The batch effect may be clearly seen in normal samples, yet the change in gene expression for cancer samples is big enough to overcome this effect. Because of this, the barcode is able to distinguish between cancer and normal bladder samples with 96% accuracy. Dyrskjot et al. do not report on the ability to distinguish normal and cancer tissue.

Genes showing the batch effect are genes with small within group variance in the normal samples yet large within group variance for cancer samples. Traditional statistical approaches, such as the t-test, penalize these genes for having large variance within the cancer group. We believe this is the wrong approach given what we know about cancer biology. The barcode approach does not necessarily penalize for this behavior. By studying the data in the context of thousands of samples we are able to distinguish genes of biological interest from those considered statistically significant yet are likely due to artifacts.

When the barcode algorithm was used to classify the breast cancer tissues, no samples were grouped with the human mammary epithelial cells (HMEC, data not shown). Instead, the good prognosis samples were found to be most similar to myometrium, lymph node and uterus. The underlying biological basis for these groupings is unclear. Although, in general, the cell line tissue samples clustered differently than the primary tissue samples. As more data is included, such as normal breast tissue, we expect the classifications for the tumor samples will change and become more refined.

A number of papers have looked for predictive gene lists in breast cancer [28-30]. A standard approach for identifying predictive genes is to take a training set of data and divide it among some important biological characteristic, such as estrogen receptor expression, and then look at differentially expressed genes between the two sets. After choosing the top ranked genes, researchers then use this predictive gene list to classify unknown samples. A major problem with this approach is it is biased by the samples placed in each group. Also, all of the previous algorithms were based on continuous data, whereas the barcode data is based on discrete data. By using discrete data, the barcode method is able to minimize the lab and batch effects and other variance components, which have plagued the previous studies. By adding carefully curated clinical tissue, we will be able to create barcodes for them and make specific disease predictions. Finally, notice that the barcode algorithm is based on a very simple detection method and distance calculation. Many aspects can be optimized for prediction purposes. For example, we might permit K to vary across genes and optimize the vector of cutoffs. A slightly more complicated classification algorithm using Random Forests, with the barcode binary data as predictors, improved the mouse results to 98%, but did not improve the human results [40]. We expect the machine learning community will help improve this already powerful algorithm so that microarray technology can fulfill its promise to help diagnose disease.

Operating Environment

The techniques described herein may operate as software, hardware, or combinations of software and hardware on, or in communication with, one or more computers.

FIG. 9 illustrates an exemplary architecture for implementing a computer. It will be appreciated that other devices that can be used with the computer 900, such as a client or a server, may be similarly configured. As illustrated in FIG. 9, computer 900 may include a bus 902, a processor 904, a memory 906, a read only memory (ROM) 908, a storage device 910, an input device 912, an output device 914, and a communication interface 916.

Bus 902 may include one or more interconnects that permit communication among the components of computer 900. Processor 904 may include any type of processor, microprocessor, or processing logic that may interpret and execute instructions (e.g., a field programmable gate array (FPGA)). Processor 904 may include a single device (e.g., a single core) and/or a group of devices (e.g., multi-core). Memory 906 may include a random access memory (RAM) or another type of dynamic storage device that may store information and instructions for execution by processor 904. Memory 906 may also be used to store temporary variables or other intermediate information during execution of instructions by processor 904.

ROM 908 may include a ROM device and/or another type of static storage device that may store static information and instructions for processor 904. Storage device 910 may include a magnetic disk and/or optical disk and its corresponding drive for storing information and/or instructions. Storage device 910 may include a single storage device or multiple storage devices, such as multiple storage devices operating in parallel. Moreover, storage device 910 may reside locally on computer 900 and/or may be remote with respect to computer 900 and connected thereto via a network and/or another type of connection, such as a dedicated link or channel.

Input device 912 may include any mechanism or combination of mechanisms that permit an operator to input information to computer 900, such as a keyboard, a mouse, a touch sensitive display device, a microphone, a pen-based pointing device, and/or a biometric input device, such as a voice recognition device and/or a finger print scanning device. Output device 914 may include any mechanism or combination of mechanisms that outputs information to the operator, including a display, a printer, a speaker, etc.

Communication interface 916 may include any transceiver-like mechanism that enables computer 900 to communicate with other devices and/or systems, such as a client, a server, a license manager, a vendor, etc. For example, communication interface 916 may include one or more interfaces, such as a first interface coupled to a network and/or a second interface coupled to a license manager. Alternatively, communication interface 916 may include other mechanisms (e.g., a wireless interface) for communicating via a network, such as a wireless network. In one implementation, communication interface 916 may include logic to send code to a destination device, such as a target device that can include general purpose hardware (e.g., a personal computer form factor), dedicated hardware (e.g., a digital signal processing (DSP) device adapted to execute a compiled version of a model or a part of a model), etc.

Computer 900 may perform certain functions in response to processor 904 executing software instructions contained in a computer-readable medium, such as memory 906. In alternative embodiments, hardwired circuitry may be used in place of or in combination with software instructions to implement features consistent with principles of the invention. Thus, implementations consistent with principles of the invention are not limited to any specific combination of hardware circuitry and software.

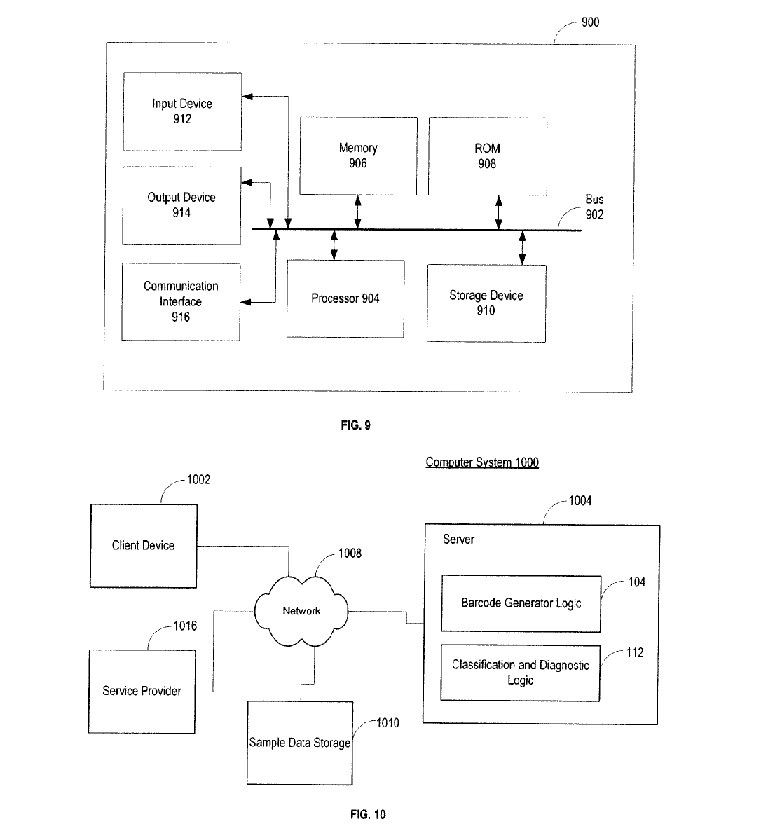

FIG. 10 depicts a computer system for use with embodiments of the present invention. The computer system 1000 may include a client computer 1002 for implementing the invention. The computer system 1000 may also, or alternatively, include a service provider 1016 coupled to a network 1008, through which the barcode creation and use techniques described herein may be requested by a user, for example, through the client computer 1002. The computer system 1000 may include a server 1004, which may include a barcode generator 104 and/or a classification and diagnostic tool 112. Client computer 1002, Service provider 1016, and/or server 1004 may access raw gene data stored in gene data storage 1010.

Exemplary embodiments of the invention may be embodied in many different ways as a software component. For example, it may be a stand-alone software package, or it may be a software package incorporated as a “tool” in a larger software product, such as, for example, a scientific analysis product. It may be downloadable from a network, for example, a website, as a stand-alone product or as an add-in package for installation in an existing software application. It may also be available as a client-server software application, or as a web-enabled software application.

The foregoing description of exemplary embodiments of the invention provides illustration and description, but is not intended to be exhaustive or to limit the invention to the precise form disclosed. Modifications and variations are possible in light of the above teachings or may be acquired from practice of the invention. For example, while a series of acts has been described with regard to FIGS. 3 and 4, the order of the acts may be modified in other implementations consistent with the principles of the invention. Further, non-dependent acts may be performed in parallel.

In addition, implementations consistent with principles of the invention can be implemented using devices and configurations other than those illustrated in the figures and described in the specification without departing from the spirit of the invention. Devices and/or components may be added and/or removed from the implementations of FIGS. 1, 9 and 10 depending on specific deployments and/or applications. Further, disclosed implementations may not be limited to any specific combination of hardware.

Further, certain portions of the invention may be implemented as “logic” that performs one or more functions. This logic may include hardware, such as hardwired logic, an application-specific integrated circuit, a field programmable gate array, a microprocessor, software, wetware, or any combination of hardware, software, and wetware.

No element, act, or instruction used in the description of the invention should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

The scope of the invention is defined by the claims and their equivalents.

### REFERENCES

1. Kothapalli, R., Yoder, S. J., Mane, S. & Loughran, T. P., Jr. (2002) BMC Bioinformatics 3, 22.
2. Kuo, W. P., Jenssen, T. K., Butte, A. J., Ohno-Machado, L. & Kohane, I. S. (2002) Bioinformatics 18, 405-12.
3. Tan, P. K., Downey, T. J., Spitznagel, E. L., Jr., Xu, P., Fu, D., Dimitrov, D. S., Lempicki, R. A., Raaka, B. M. & Cam, M. C. (2003) Nucleic Acids Res 31, 5676-84.
4. Irizarry, R. A., Warren, D., Spencer, F., Kim, I. F., Biswal, S., Frank, B. C., Gabrielson, E., Garcia, J. G., Geoghegan, J., Germino, G., et al. (2005) Nat Methods 2, 345-50.
5. Li, C. & Wong, W. H. (2001) Proc Natl Acad Sci USA 98, 31-6.
6. Shippy, R., Sendera, T. J., Lockner, R., Palaniappan, C., Kaysser-Kranich, T., Watts, G. & Alsobrook, J. (2004) BMC Genomics 5, 61.
7. Carter, S. L., Eklund, A. C., Mecham, B. H., Kohane, I. S. & Szallasi, Z. (2005) BMC Bioinformatics 6, 107.
8. Mecham, B. H., Klus, G. T., Strovel, J., Augustus, M., Byrne, D., Bozso, P., Wetmore, D. Z., Mariani, T. J., Kohane, I. S. & Szallasi, Z. (2004) Nucleic Acids Res 32, e74.
9. Bammler, T., Beyer, R. P., Bhattacharya, S., Boorman, G. A., Boyles, A., Bradford, B. U., Bumgarner, R. E., Bushel, P. R., Chaturvedi, K., Choi, D., et al. (2005) Nat Methods 2, 351-6.
10. Shi, L., Tong, W., Fang, H., Scherf, U., Han, J., Puri, R. K., Frueh, F. W., Goodsaid, F. M., Guo, L., Su, Z., et al. (2005) BMC Bioinformatics 6 Suppl 2, S12.
11. Shi, L., Shi, L., Reid, L. H., Jones, W. D., Shippy, R., Warrington, J. A., Baker, S. C., Collins, P. J., de Longueville, F., Kawasaki, E. S., et al. (2006) Nat Biotechnol 24, 1151-1161.
12. Draghici, S., Khatri, P., Eklund, A. C. & Szallasi, Z. (2006) Trends Genet 22, 101-9.
13. (2006) Nat Biotechnol 24, 1039.
14. Irizarry, R. A., Wu, Z. & Jaffee, H. A. (2006) Bioinformatics 22, 789-94.
15. Ein-Dor, L., Zuk, 0. & Domany, E. (2006) Proc Natl Acad Sci USA 103, 5923-8.
16. Ein-Dor, L., Kela, I., Getz, G., Givol, D. & Domany, E. (2005) Bioinformatics 21, 171-8.
17. Michiels, S., Koscielny, S. & Hill, C. (2005) Lancet 365, 488-92.
18. Brenton, J. D., Carey, L. A., Ahmed, A. A. & Caldas, C. (2005) J Clin Oncol 23, 7350-60.
19. Rosenwald, A., Wright, G., Chan, W. C., Connors. J. M., Campo, E., Fisher, R. I., Gascoyne, R. D., Muller-Hermelink, H. K., Smeland, E. B., Giltnane, J. M., et al. (2002) N Engl J Med 346, 1937-47.
20. Shipp, M. A., Ross, K. N., Tamayo, P., Weng, A. P., Kutok, J. L., Aguiar, R. C., Gaasenbeek, M., Angelo, M., Reich, M., Pinkus, et al. (2002) Nat Med 8, 68-74.
21. Sorlie, T., Tibshirani, R., Parker, J., Hastie, T., Marron, J. S., Nobel, A., Deng, S., Johnsen, H., Pesich, R., Geisler, S., et al. (2003) Proc Nati Acad Sci USA 100, 8418-23.
22. Barrett, T., Suzek, T. O., Troup, D. B., Wilhite, S. E., Ngau, W. C., Ledoux, P., Rudnev, D., Lash, A. E., Fujibuchi, W. & Edgar, R. (2005) Nucleic Acids Res 33, D562-6.
23. Parkinson, H., Sarkans, U., Shojatalab, M., Abeygunawardena, N., Contrino, S., Coulson, R., Fame, A., Lara, G. G., Holloway, E., Kapushesky, M., et al. (2005) Nucleic Acids Res 33, D553-5.
24. Blalock, E. M., Geddes, J. W., Chen, K. C., Porter, N. M., Markesbery, W. R. & Landfield, P. W. (2004) Proc Natl Acad Sci USA 101, 2173-8.
25. Kimchi, E. T., Posner, M. C., Park, J. O., Darga, T. E., Kocherginsky, M., Karrison, T., Hart, J., Smith, K. D., Mezhir, J. J., Weichselbaum, R. R., et al. (2005) Cancer Res 65, 3146-54.
26. Dyrskjot, L., Kruhoffer, M., Thykjaer, T., Marcussen, N., Jensen, J. L., Moller, K. & Orntoft, T. F. (2004) Cancer Res 64, 4040-8.
27. Lenburg, M. E., Liou, L. S., Gerry, N. P., Frampton, G. M., Cohen, H. T. & Christman, M. F. (2003) BMC Cancer 3, 31.
28. Miller, L. D., Smeds, J., George, J., Vega, V. B., Vergara, L., Ploner, A., Pawitan, Y., Hall, P., Klaar, S., Liu, et al. (2005) Proc Natl Acad Sci USA 102, 13550-5.
29. Pawitan, Y., Bjohle, J., Amler, L., Borg, A. L., Egyhazi, S., Hall, P., Han, X., Holmberg, L., Huang, F., Klaar, S., et al. (2005) Breast Cancer Res 7, R953-64.
30. Sotiriou, C., Wirapati, P., Loi, S., Harris, A., Fox, S., Smeds, J., Nordgren, H., Farmer, P., Praz, V., Haibe-Kains, B., et al. (2006) J Natl Cancer Inst 98, 262-72.
31. Bolstad, B. M., Collin, F., Brettschneider, J., Simpson, K., Cope, L., Irizarry, R. A., and Speed, T. P. (2005) Bioinformatics and Computational Biology Solutions Using R and Bioconductor (Springer, New York, N.Y.).
32. Irizarry, R. A., Gautier, L., and Cope, L. M. (2003) in The Analysis of Gene Expression Data: Methods and Software, ed. Parmigiani, G., Garrett, E. S., Irizarry, R. A., and Zeger, S. I. (Springer-Verlag, New York).
33. Kislinger, T., Cox, B., Kannan, A., Chung, C., Hu, P., Ignatchenko, A., Scott, M. S., Gramolini, A. O., Morris, Q., Hallett, M. T., et al. (2006) Cell 125, 173-86.
34. Dudoit, S. F., J., and Speed, T. P. (2002) Journal of the American Statistical Association 97, 77-87.
35. Tibshirani, R., Hastie, T., Narasimhan, B. & Chu, G. (2002) Proc Natl Acad Sci USA 99, 6567-72.
36. Golub, T. R., Slonim, D. K., Tamayo, P., Huard, C., Gaasenbeek, M., Mesirov, J. P., Coller, H., Loh, M. L., Downing, J. R., Caligiuri, M. A., Bloomfield, C. D. & Lander, E. S. (1999) Science 286, 531-7.
37. van de Vijver, M. J., He, Y. D., van′t Veer, L. J., Dai, H., Hart, A. A., Voskuil, D. W., Schreiber, G. J., Peterse, J. L., Roberts, C., Marton, M. J., et al. (2002) N Engl J Med 347, 1999-2009.
38. Bolstad, B. M., Irizarry, R. A., Astrand, M. & Speed, T. P. (2003) Bioinformatics 19, 185-93.
39. Zhang, J., Finney, R. P., Clifford, R. J., Derr, L. K. & Buetow, K. H. (2005) Genomics 85, 297-308.
40. Breiman, L. (2001) Machine Learning 45, 5-32.

1. A computer-based method of creating a gene expression barcode, comprising:
determining an intensity of expression for each gene in a set of genes in a plurality of samples for at least one tissue type;
selecting genes in the set of genes that have at least two expression modes, based on the intensity; and
creating a gene expression reference barcode, wherein each barcode bar corresponds to a selected gene and wherein the bar value is coded according to whether an intensity value for a selected gene is below or above a threshold value.

2. The method of claim 1, further comprising:
outputting the gene expression reference barcode.

3. The method of claim 1, further comprising:
determining the threshold value based on an intensity of expression of an unexpressed gene.

4. The method of claim 3, further comprising: determining the threshold value as a constant multiplied by the intensity of expression of the unexpressed gene.

5. The method of claim 4, wherein the constant is six.

6. The method of claim 1, further comprising:
storing an unexpressed mean and a standard deviation for each selected gene.

7. The method of claim 1, further comprising:
classifying a sample of unknown tissue type, comprising:
creating a sample gene expression barcode for the unknown sample;
identifying at least one gene expression reference barcode being closest in distance to the sample gene expression barcode; and
identifying a tissue type for the unknown sample as being the same tissue type as the at least one reference barcode having the shortest distance to the sample gene expression barcode within a threshold value.

8. The method of claim 7, wherein identifying the at least one gene expression reference barcode being closest in distance to the sample barcode comprises:
calculating a distance as being at least one of:
a number of genes that are expressed in the sample barcode and not expressed in the gene expression reference barcode; or
a number of genes that are not expressed in the sample barcode and are expressed in the gene expression reference barcode; and
identifying the smallest distance calculated as the closest distance.

9. The method of claim 7, further comprising:
diagnosing a disease in the unknown sample when the identified tissue type is for a diseased reference barcode.

10. The method of claim 9, further comprising determining a prognosis when the identified tissue type is for a disease tissue type of estimated prognosis.

11. The method of claim 7, wherein identifying a tissue type comprises identifying at least one of: an organ, a disease condition, a tissue of origin of a metastatic cancer, or a disease prognosis.

12. A gene expression barcode created by the method of claim 1.

13. The method of claim 1, wherein selecting genes in the set of genes that have at least two expression modes, based on the intensity comprises selecting genes that have only two expression modes.

14. A computer-readable medium comprising instructions, which when executed by a computer system causes the computer system to perform operations for creating a gene expression barcode, the operations comprising:
determining an intensity of expression for each gene in a set of genes in a plurality of samples for at least one tissue type;
selecting genes in the set of genes that have at least two expression modes, based on the intensity; and
creating a gene expression reference barcode, wherein each barcode bar corresponds to a selected gene and wherein the bar value is coded according to whether an intensity value for a selected gene is below or above a threshold value.

15. A computer-based method for classification of a biological sample, comprising:
generating a gene expression barcode for a sample;
comparing the gene expression barcode to at least one reference gene expression barcode; and
identifying a tissue type of the sample based on a closest distance to one reference gene expression barcode.

16. The method of claim 15, further comprising: outputting the identified tissue type.

17. The method of claim 15, further comprising diagnosing the disease in the sample when the identified tissue type is a diseased tissue.

18. The method of claim 17, further comprising providing a disease prognosis in the sample when the identified disease tissue type is a diseased tissue of estimated prognosis.

19. The method of claim 17, further comprising outputting at least one of the diagnosed disease or the disease prognosis.

20. A computer-based system for using a gene expression barcode comprising:
a database containing at least one gene expression reference barcode for at least one tissue type;
a barcode generator for generating a gene expression barcode for a sample;
a classification and diagnostic tool for identifying a tissue type of the sample by comparing the gene expression barcode of to the at least one gene expression reference barcode; and
means for outputting a result of the comparing.

21. The computer based system of claim 20, wherein the means for outputting comprises at least one of: a display, a printer, or a file stored in a computer readable medium.

22. The computer based system of claim 20, wherein the tissue type comprises at least one: an organ, a disease condition, a tissue of origin of a metastatic cancer, or a disease prognosis.
